(19) United States
(12) Patent Application Publication
(10) Pub. No.: US 2019/0069113 A1
(43) Pub. Date: Feb. 28, 2019

(54) Novel Method for Reducing Acoustic Phase Distortions in a Motor Vehicle

(71) Applicant: Claude Carpentier, Maisons Laffitte (FR)

(72) Inventor: Claude Carpentier, Maisons Laffitte (FR)

(21) Appl. No.: 15/768,982

(22) PCT Filed: Oct. 17, 2016
(86) PCT No.: PCT/FR2016/000169

§ 371 Date: Apr. 17, 2018

(30) Foreign Application Priority Data
Oct. 20, 2015 (FR) 15/02209

(51) Int. Cl. H04S 7/00; H04S 1/00; H04R 5/02

(52) U.S. Cl. CPC H04S 7/301; H04R 2499/13; H04R 5/02; H04S 1/002

(57) ABSTRACT

The method of the invention uses the difference between the acoustic distortions at the left-hand and right-hand front locations mainly in the frequency bands for which said distortions have different signs.

The present invention relates to a novel method for reducing acoustic phase distortions in automobile stereophonic reproduction.

All passenger vehicles manufactured by automakers are equipped with a loudspeakers system designed to reproduce stereophonic modulations.

The stereophonic process makes it possible to obtain a continuous and homogeneous sound image from two point sources provided that the listener is located equidistant from these two sources.

However, it is impossible for two listeners seated side by side in an automobile to be equidistant from two loudspeakers reproducing the left and right channels.

The difference in distance between the speakers and the listeners generates distortions of levels and acoustic phases between the 2 channels which deeply degrade the stereophonic reproduction in the car.

The methods to remedy this fall into two categories. On the one hand, the so-called mono-stereophonic methods which aim to improve the sound image for a listener, generally the driver, without worrying about the consequences for the other listener, and on the other hand the bi-stereophonic methods which aim to improve the quality of listening for both side-by-side listeners.

The present invention belongs to the category of bi-stereophonic methods.

In what follows, we will call acoustic phase the phase difference between the two channels at a listening location.

In what follows, we will call “stereophonic phase distortion” the phase difference at a point of listening between the sound waves emitted by the loudspeakers when they emit the same signal.

According acousticians works especially STEVENS and NEWMAN it appears that the phase is involved in the location of sound sources in the frequency band between about 100 Hz and 1500 Hz. We therefore limited our measurements to the band 31.5 Hz-1600 Hz and our phase distortion calculations at the band 100 Hz-1600 Hz, the low frequencies not intervening in the formation of the sound image.

Numerous methods have been proposed for improving the rendering of stereophonic modulations in automobiles. U.S. Pat. No. 4,817,162 to Pioneer, U.S. Pat. No. 5,033,092 to Onkyo, No. 60/338,323 to Harman, No. WO 2007/106551 to Dolby and our French patents Nos. 2,839,602 and 2,985,144 are known.

All of these methods advocate reversing the stereo phase in certain frequency bands in order to reduce the acoustic phase distortion between the channels and they differ mainly in the operating mode used.

Inverting the stereophonic phase consists in applying a phase difference of 180° between the two channels, for example by inverting the phase of one of the two channels.

Whatever the method used, when the stereophonic phase is reversed, the phase distortion changes sign and its modulus becomes the 180° complement of the original distortion.

Insofar as the acoustic phase distortions at the listening points exceed 90° in certain frequency bands, reversing the stereophonic phase in these frequency bands decreases the modulus of the acoustic phase distortion and thus improves the restitution of stereophonic modulations.

However, none of the aforementioned patents mentions the difference between the phase distortions at the two listening positions at the front of the car caused by the layout of the driving position.

The present invention is a novel method for improving automobile stereophonic reproduction in a real vehicle to obtain a better result than that obtained by the known methods, and this by using the difference between the phase distortions at the two locations of listening.

For this, we will consider on the one hand [Φ_{L}−Φ_{R}]_{L} that is the phase difference between the acoustic wave from the left speaker and that from the right speaker for the listening position to the left of the car.

And secondly [Φ_{R}−Φ_{L}]_{R} that is the phase difference between the acoustic wave coming from the right speaker and that coming from the left speaker for the listening position to the right of the car.

We tested our new method in a real vehicle equipped at the front of a classic configuration ie with speakers at the bottom of the door reproducing the bass and midrange registers, and tweeters at the ends of the dashboard reproducing the high frequencies.

A microphone was placed at each listening position and a pink noise signal was successively applied to each left and right speaker.

To measure the phase difference[Φ_{L}−Φ_{R}]_{L} we proceed in two stages.

First, a signal is applied to the left speaker and the phase difference [Φ_{L}−Φ_{S}]_{L} between the signal generated by the left microphone and the signal applied to the left speaker is measured.

In a second step, a signal is applied to the right speaker and the phase difference [Φ_{R}−Φ_{S}]_{L} between the signal generated by the left microphone and the signal applied to the right speaker is measured.

And we have:

[Φ_{L}−Φ_{R}]_{L}=[Φ_{L}−Φ_{S}]_{L}−[Φ_{R}−Φ_{S}]_{L} (1)

Repeating the same procedure with the right microphone we get

[Φ_{R}−Φ_{L}]_{R}=[Φ_{R}−Φ_{S}][Φ_{L}−Φ₅]_{R} (2)

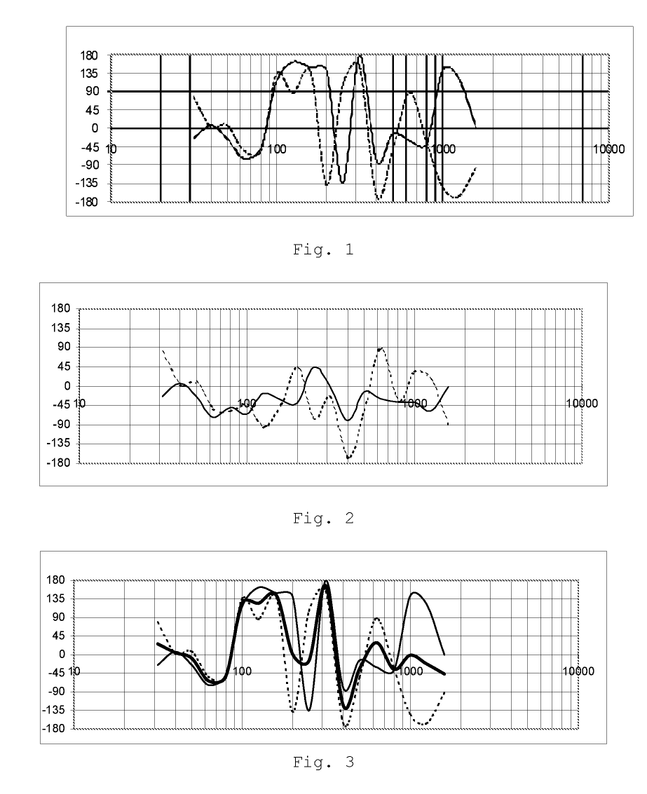

In FIG. 1 the curve in solid line is [Φ_{L}−Φ_{R}]_{L} and the dotted curve is [Φ_{R}−Φ^{L}]_{R}.

The average phase distortion (average absolute values between 100 Hz and 1600 Hz) is 101° driver side and 116° passenger side a total of 217° an average of 108.5°.

In FIG. 2, the solid line curve is the residual phase distortion on the driver side and the dotted curve is the residual phase distortion on the passenger side after application of a phase inversion of a channel according to the conventional method at frequencies favoring the driver, namely between 100 Hz and 315 Hz and between 1000 Hz and 1250 Hz. In these conditions the residual distortions are 34° driver side and 62° passenger side a total of 96° and an average 48°.

The first of the two main ideas of the present invention is to apply a specific treatment to the frequency bands for which [Φ_{L}−Φ_{R}]_{L} and [Φ_{R}−Φ_{L}]_{R} are not of the same sign.

Suppose [Φ_{L}−Φ_{R}]_{L}=+90° and [Φ_{R}−Φ_{L}]_{R}=90° if we delay the left channel by 90° we get[Φ_{L}−Φ_{R}]_{L}=0° and [Φ_{R}−Φ_{L}]_{R}=0°. We canceled the stereophonic phase distortion for both listening positions!

Suppose now [Φ_{L}−Φ_{R}]_{L}=+100° and [Φ_{R}−Φ_{L}]_{R}=−50° totaling absolute values of 150°.

By delaying the left channel by 50° we obtain a residual distortion of +50° on the left and 0° on the right, ie a total of 50°.

By delaying the left channel by 60° we obtain a residual distortion of +40° on the left and +10° on the right, ie a total of 50°.

By delaying the left channel by 70° we obtain a residual distortion of +30° on the left and +20° on the right, ie a total of 50°.

By delaying the left channel by 80° we obtain a residual distortion of +20° on the left and +30° on the right, ie a total of 50°.

By delaying the left channel by 90° we obtain a residual distortion of +10° on the left and +40° on the right, ie a total of 50°.

By delaying the left channel by 100° we obtain a residual distortion of 0° on the left and +50° on the right, ie a total of 50°.

Delaying the left channel less than 50° or more than 100° gives a total of distortions of more than 50°. And we see that in this case, distortions on the right and left have no longer the same sign.

And so we can deduce the following rule: the necessary and sufficient condition to obtain a minimum of total distortion at a frequency for which the distortions on the right and on the left are not of the same sign is to apply a phase shift between them that make them the same sign.

If we take again the case where the distortions are +90° and −90° there is only for zero that they have the same sign.

After this operation we have distortions on the right and left of the same sign in each frequencies band, this sign is not necessarily the same at all frequencies.

The sum of the distortions obtained is then equal to the difference between the original distortions.

The question now is when to invert the phase of a channel to obtain after inversion the minimum of total distortion.

The answer is: when the sum of the two distortions exceeds 180°.

Let's go back now to the case where [Φ_{L}−Φ_{R}]_{L}=+100° and

[Φ_{R}−Φ_{L}]_{R}=−50°.

We have seen that applying a delay of 70° to the left channel gives a distortion of +30° on the left and +20° on the right and that applying a delay of 80° on the left one obtained a distortion of +20° left and +30° right.

From this we can deduce that by applying a 75° delay to the left we get +25° for the left and right distortion.

The second main idea of the present invention is that the stereophonic phase distortion is probably symmetrizable. What we will check.

The condition of symmetry of the sound images perceived by the driver and the passenger with respect to the longitudinal plane of symmetry of the car in terms of phase is written:

[Φ_{L}−Φ_{R}]_{L}=[Φ_{R}−Φ_{L}]_{R} (3)

If ΔΦ_{L} is the phase correction to be applied to the left channel to symmetrize the phase distortions. If symmetrization is possible, ΔΦ_{L} must be the solution of the equation:

[Φ_{L}−Φ_{R}]_{L}+ΔΦ_{L}=[Φ_{R}−Φ_{L}]_{R}−ΔΦ_{L} (4)

Equation (4) has a solution that is:

$${ΔΦ}_{G} = \frac{{[ {Φ}_{R} - {Φ}_{L} ]}_{R} - {[ {Φ}_{L} - {Φ}_{R} ]}_{L}}{2} \qquad ( 5 )$$

The same result is obtained by shifting the phase of the right channel from:

$${ΔΦ}_{R} = \frac{{[ {Φ}_{L} - {Φ}_{R} ]}_{L} - {[ {Φ}_{R} - {Φ}_{L} ]}_{R}}{2} \qquad ( 6 )$$

or simultaneously correcting the phase of the left and right channels respectively of

$$\frac{{ΔΦ}_{L}}{2} and \frac{{ΔΦ}_{R}}{2} .$$

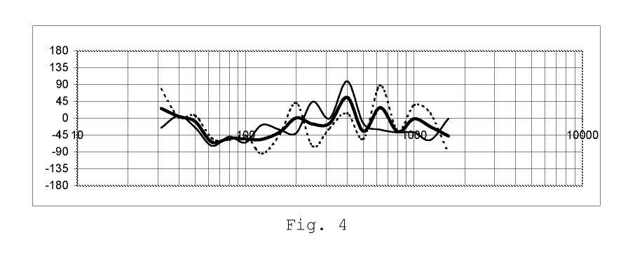

In FIG. 3, the curves in thin lines are the original distortions and the thick curve is the symmetrized phase distortion which stands at an average of 66°.

Note the considerable reduction of distortion at frequencies where the original distortions were not the same sign especially around 1000 Hz.

In FIG. 4 the fine-line curves are the left and right distortions obtained by the traditional method, that is to say the curves of FIG. 2, and the curve in thick line is the residual distortion after symmetrization and inversion of the phase of a channel between 100 Hz and 160 Hz and between 315 Hz and 400 Hz. The residual distortion is now on both sides at 31 Hz, a total of 62° compared to the total of 96° that we obtain with the old method which represents a 35% decrease in total distortions.

This improvement is due to the treatments applied to the frequencies where the distortions do not have the same sign. The symmetrization being a special case.

In some cases, we can opt for a symmetrical setting and in others cases we will prefer slightly to favor a listener.

But in both cases it will be more comfortable to perform the first symmetrization which automatically addresses the case of frequencies for which the distortions do not have the same sign and gives a clear view of the quality of the configuration.

From this symmetrization, it is possible to make phase modifications for example to slightly favor one channel with respect to the other. The necessary and sufficient condition not to increase the total distortion is to preserve for the two distortions the sign obtained after symmetrization.

This process may be the subject of an electro-acoustic device for equipping motor vehicles.

1. A method for adjusting the stereophonic phase of an automobile sound reproduction installation of the type consisting of inverting the electrical phase between the two channels in certain frequency bands and characterized by the fact that a change of the relative phase between the left and right channels is operated for the frequencies where the phase distortions between the channels for the two listening positions [Φ_{L}−Φ_{R}]_{L} and [Φ_{R}−Φ_{L}]_{R} are of different signs to make them of the same sign.

2. A method for adjusting the stereophonic phase of an automobile sound reproduction installation according to claim 1 and characterized in that the electrical phase is reversed between the two channels at frequencies where the modulus of the sum of the distortions phase at the left and right listening positions is greater than 180°.

3. A method according to claim 1 and characterized by the fact that one proceeds to symmetrize the stereophonic phase distortion at the two listening positions by applying between the two channels a shift of the stereophonic phase equal to half of the difference in acoustic phase distortions between the two channels at the two listening positions.

4. Device for reproducing stereophonic modulations in the automobile for the implementation of the method according to claim 1 comprising an electronic control unit and power and several speakers.

5. A motor vehicle equipped with a sound modulation reproduction device according to claim 4.
